(19) United States
(12) Patent Application Publication
(10) Pub. No.: US 2014/0176982 A1
(43) Pub. Date: Jun. 26, 2014

(54) METHOD AND SYSTEM FOR MANAGING PRINT STOCK INFORMATION USING A CLOUD ADMINISTRATION SYSTEM

(71) Applicant: XEROX CORPORATION, Norwalk, CT (US)

(72) Inventor: Robert William Burke, JR., Stanley, NY (US)

(73) Assignee: XEROX CORPORATION, Norwalk, CT (US)

(21) Appl. No.: 13/723,518

(22) Filed: Dec. 21, 2012

(51) Int. Cl. G06K 15/02

(52) U.S. Cl. CPC G06K 15/021
USPC 358/1.14; 358/1.15

(57) ABSTRACT

A cloud administration system for managing stock information in a network printing context may include a processing module in communication with a plurality of print devices. The processing module may be located remotely from the plurality of print devices. The cloud administration system may include one or more storage modules in communication with the processing module. The processing module may be configured to receive stock information from at least one of the plurality of print devices, store the stock information in at least one of the storage modules, and enable a remote system to access at least a portion of the stock information from the storage module. The remote system may be located remotely from the processing module. The cloud administration system may operate as a shared resource for each of the plurality of print devices and the remote system.

### BACKGROUND

Typically, print-related services and solutions require providing onsite resources to a customer, such as software, hardware and personnel. In addition, numerous print-related services and solutions may operate autonomously, even though they utilize similar delivery mechanisms and backend connectivity. As such, providing print-related services can often be costly and inefficient.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a cloud administration system for managing stock information in a network printing context may include a processing module in communication with a plurality of print devices. The processing module may be located remotely from the plurality of print devices. The cloud administration system may include one or more storage modules in communication with the processing module. The processing module may be configured to receive stock information from at least one of the plurality of print devices, store the stock information in at least one of the storage modules, and enable a remote system to access at least a portion of the stock information from the storage module. The remote system may be located remotely from the processing module. The cloud administration system may operate as a shared resource for each of the plurality of print devices and the remote system.

In an embodiment, a system for managing stock information in a network printing context may include a computing device and a computer-readable storage medium in communication with the computing device. The computer-readable storage medium may include one or more programming instructions that, when executed, cause the computing device to access, from a storage module of a cloud administration system, stock information associated with one or more print devices in communication with the cloud administration system, analyze the accessed stock information to identify one or more patterns associated with the accessed stock information, alert a user of the one or more print devices of the identified patterns, and present the user with one or more recommendations based on the identified patterns.

In an embodiment, a method of managing stock information in a network printing context may include receiving, by a cloud administration system from a print device located remotely from the cloud administration system, stock information associated with the print device, storing, by the cloud administration system, the stock information in a storage module, and enabling, by the cloud administration system, a remote system to access at least a portion of the stock information from the storage module. The cloud administration system may operate as a shared resource for each of the plurality of print devices and the remote system.

In an embodiment, a method of managing stock information in a network printing context may include receiving, by a cloud administration system, a request to access at least a portion of the information in a stock library. The stock library may include information pertaining to one or more stocks. The request may include an identifier associated with a print device. The method may include identifying, by the cloud administration system, one or more possible stocks that are available for use by the print device from the stock library based on the identifier, causing information associated with the identified possible stocks to be displayed at the print device, receiving a selection of one of the identified possible stocks, receiving an indication of a tray of the print device associated with the selected stock, and storing, by the cloud administration system, the selection and the indication in the stock storage module.

### BRIEF DESCRIPTION OF THE DRAWINGS

FIGS. 1 and 2 illustrate example cloud administration systems according to an embodiment.

FIG. 3 illustrates an example of a stock storage module according to an embodiment.

FIG. 4 illustrates a flow chart of an example method of utilizing stock information according to an embodiment.

FIG. 5 illustrates an example implementation of a cloud administration system according to an embodiment.

FIG. 6 depicts a block diagram of example internal hardware that may be used to contain or implement program instructions according to an embodiment.

FIG. 7 illustrates an example of stock library according to an embodiment.

FIG. 8 illustrates an example method of accessing a stock library according to an embodiment.

### DETAILED DESCRIPTION

The following terms shall have, for the purposes of this application, the respective meanings set forth below.

An “application computing device” is a computing device capable of sending information to and/or receiving information from a cloud administration system.

A “cloud administration system” refers to one or more physical and/or logical devices that operate as a shared resource for multiple remote print devices and/or computing devices. Logical devices in a cloud administration system may be accessed without any knowledge of the corresponding physical devices.

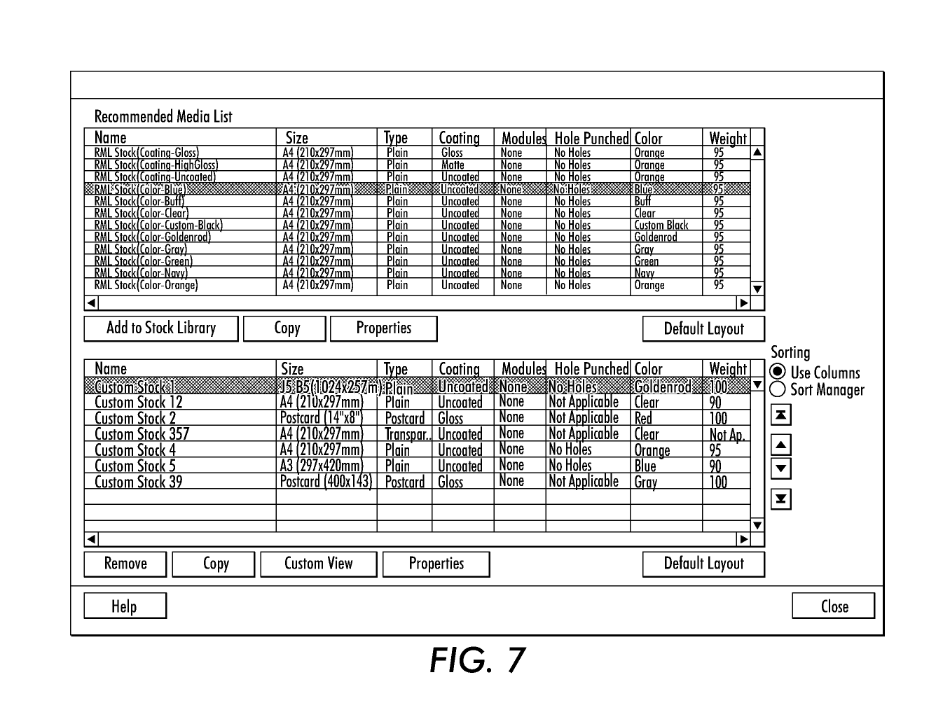

A “computing device” or a “processor” refers to a computer or other machine that performs one or more operations according to one or more programming instructions. An example computing device or processor is described in reference to FIG. 7.

“Fault information” refers to information or data pertaining to one or more faults relating to stock usage that are experienced by a print device over a period of time.

A “firewall” is hardware and/or software used to protect a resource of a network from unauthorized external access.

A “job” refers to a logical unit of work that is to be completed for a customer.

A “logical device” is a representation of a physical device that uniquely identifies the corresponding physical device. For example, a network interface may be assigned a unique media access control address that is the logical unique identifier of a physical device. As such, a conventional device is a combined logical and physical device in which the logical device provides the entire identity of the physical device.

A “module” is a component of a larger system, such as a cloud administration system.

An “operation” or “print-related function” is a function that is performed on a print job. Example operations may include raster image processing, formatting, stapling, collating, sorting, punching, binding and/or the like.

A “physical device” is a physical resource such as a computing device, a computer-readable storage medium and/or the like.

A “print job” refers to a job that can be processed by a print device. For example, a print job may include a job that is to be printed, scanned or otherwise processed by a print device.

A “print device” refers to a device capable of performing one or more print-related functions. For example, a print device may include a printer, a scanner, a copy machine, a multifunction device, a collator, a binder, a cutter or other similar equipment. A “multifunction device” is a device that is capable of performing two or more distinct print-related functions. For example, a multifunction device may have print and scan capabilities.

A “queue” is a data structure stored on a computer-readable medium and configured to temporarily store information, including, but not limited to, a print job, print device information and/or the like.

“Stock” refers to media (i.e., a substrate) onto which a print job is to be processed. Stock may include, for example, paper, cardboard, plastic, or other media.

“Stock information” refers to stock usage information, fault information and/or stock inventory information.

“Stock inventory information” refers to information or data pertaining to an inventory level of stock for one or more print devices.

“Stock usage information” refers to information or data pertaining to the usage of a stock by one or more print devices over a period of time.

The term “remote,” as used herein with respect to computing devices and/or print devices, refers to devices that operate on different computer networks and/or computer networks operated by different entities. For example, a computing device is remote from a print device if the computing device is connected to a first LAN operated by a first entity and the print device is connected to a second LAN operated by a second entity.

A “resource” is a physical device having a processor and/or a storage medium. Example resources may include a computing device, a processing device, a storage device and/or the like.

A “shared resource” is a resource that may be accessed and used by a plurality of other resources.

A “source computing device” is a computing device that is capable of transmitting one or more print jobs to a cloud administration system.

A “storage module” or “SM” is a computer-readable storage medium or portion thereof.

“Virtualization” is a configuration that allows logical devices to exist as an abstraction without being directly tied to a specific physical device. Virtualization may be achieved using logical names instead of physical identifiers. For example, using a uniform resource locator instead of a server's media access control address effectively virtualizes the target server. Alternatively, an assigned media access control address may exist independently of the physical resources managing network traffic.

A cloud administration system may help print device users and operators more effectively manage stock information associated with such print devices. Typically, a media guide in the form of a document such as a PDF or a spreadsheet is made available to users. The media guide may identify which types of media are available for a particular print device based on one or more factors such as, for example, geographic operating regions. A device operator must read through the media guide to locate a particular stock and manually enter settings for each stock in each paper tray of the print device via a user interface, such as a paper tray management interface of the print device.

Storing stock information in a cloud context may provide a user a more efficient way to locate, manage and update stock information for print devices. In addition, a cloud administration system may aggregate and/or analyze stock information from multiple print devices to detect patterns of usage that may be of value to a print device user or operator.

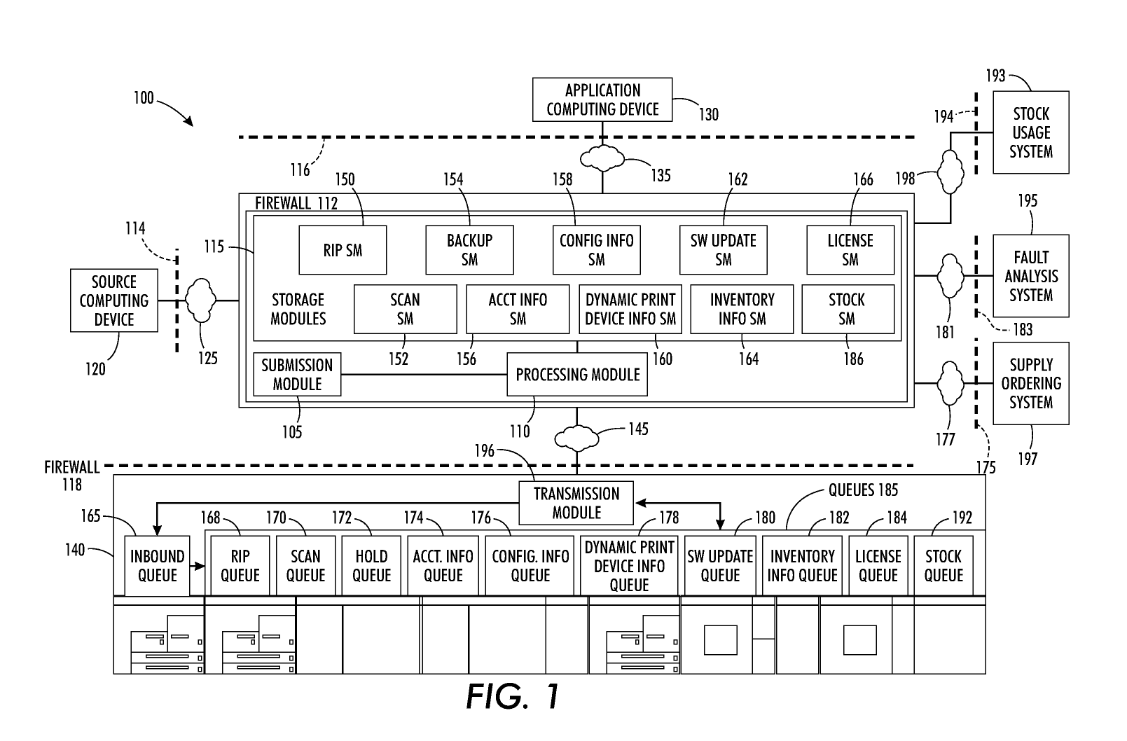

FIG. 1 illustrates an example cloud administration system according to an embodiment. As illustrated by FIG. 1, a cloud administration system 100 may include a submission module 105, a processing module 110 and one or more storage modules 115. The submission module 105 and/or one or more of the storage modules 115 may be in communication with the processing module 110. In an embodiment, all communication to or from the cloud administration system 100 may be through a firewall 112.

In an embodiment, a storage module 115 may correspond to an operation or type of operation to be performed on a print job, or it may correspond to the type of information it stores. For example, as illustrated by FIG. 1, the storage modules 115 may include a raster image processing (RIP) storage module 150, a scan storage module 152, a backup storage module 154, an accounting information storage module 156, a configuration information storage module 158, a dynamic print device information storage module 160, a software update storage module 162, an inventory information storage module 164, a license storage module 166, a stock storage module 186 and/or the like. Storage modules 115 are discussed in more detail below.

In an embodiment, a cloud administration system 100 may be in communication with one or more source computing devices 120. A source computing device 120 may be located remotely from the cloud administration system 100. In an embodiment, all source computing devices 120 may be located remotely from the cloud administration system 100. In an embodiment, a source computing device 120 may communicate with a cloud administration system 100 through a plurality of firewalls. For example, a communication from a source computing device 120 to a submission module 105 may pass through a firewall 114 associated with the source computing device and the firewall 112 associated with the cloud administration system 100.

In an embodiment, a source computing device 120 may communicate directly with a cloud administration system 100 over a network 125. In an embodiment, the network 125 may be operated by an entity. An entity may be a corporation, an organization, a group, an individual and/or the like. In an embodiment, a plurality of source computing devices 120 may communicate with the cloud administration system 100 over one or more networks.

In an embodiment, a cloud administration system 100 may be in communication with one or more application computing devices 130. An application computing device 130 may be in communication with the processing module 110 and/or one or more storage modules 115. In an embodiment, an application computing device 130 may communicate with the cloud administration system 100 through a plurality of firewalls. For example, a communication from an application computing device 130 to a processing module 110 may pass through a firewall 116 associated with the application computing device and the firewall 112 associated with the cloud administration system 100.

In an embodiment, an application computing device 130 may be located remotely from the cloud administration system 100. In an embodiment, each application computing device 130 may be located remotely from the cloud administration system 100. In an alternate embodiment, an application computing device 130 may be a component of the cloud administration system 100.

An application computing device 130 may communicate with the cloud administration system 100 over a network 135. In an embodiment, an application computing device 130 may communicate directly with a submission module 105 over a network 135. In an embodiment, an application computing device 130 may communicate with a submission module 105 through one or more firewalls.

An application computing device 130 may be located remotely from a source computing device 120. In an embodiment, each application computing device 130 may be located remotely from each source computing device 120. In an embodiment, the network 135 over which an application computing device 130 may communicate with a cloud administration system 100 may be operated by a different entity than that which operates a network over which a source computing device 120 may communicate with the cloud administration system.

In an embodiment, a cloud administration system 100 may be in communication with one or more print devices 140. A print device 140 may be located remotely from the cloud administration system 100 and may communicate with the cloud administration system over one or more networks 145. In an embodiment, each print device 140 may be located remotely from the cloud administration system 100.

In an embodiment, a print device 140 may communicate with a cloud administration system 100 through a plurality of firewalls. For example, a communication from a print device 140 to a cloud administration system 100 may pass through a firewall 118 associated with the print device and the firewall 112 associated with the cloud administration system 100.

In an embodiment, a print device 140 may be located remotely from a source computing device 120 and an application computing device 130. In an embodiment, each print device 140 may be located remotely from each source computing device 120 and each application computing device 130. In an embodiment, the network 145 over which a print device 140 may communicate with a cloud administration system 100 may be operated by an entity that is different than that which operates a network over which a source computing device 120 may communicate with the cloud administration system and/or a network over which an application computing device 130 may communicate with the cloud administration system.

In an embodiment, a print device 140 may have one or more queues 185 that may be inbound and/or outbound queues. Although inbound and outbound queues are discussed as being separate queues, it is understood that an inbound queue may perform inbound and outbound queue functions, and that an outbound queue may perform outbound and inbound functions.

In an embodiment, a print device 140 may have an inbound queue 165, such as a spooler and/or the like. An inbound spooler may be a queue that receives, stores, schedules and/or requests printing of a print job. In an embodiment, a print device 140 may have one or more outbound queues 185. An outbound queue may store print jobs and/or print device information until the print device transmits these print jobs and/or print device information. For example, as illustrated by FIG. 1, a print device may have a RIP queue 168, a scan queue 170, a hold queue 172, an accounting information queue 174, a configuration information queue 176, a dynamic print device information queue 178, a software update queue 180, an inventory information queue 182, a license queue 184, a stock queue 192 and/or the like. Queues 185 are discussed in more detail below.

In an embodiment, a print device 140 may have a transmission module 196. A transmission module may be in communication with one or more queues 185. A transmission module 196 may be configured to transmit data from a print device 140 to a computing device, another print device and/or the like. In an embodiment, a transmission module 196 may be in communication with a cloud administration system 100. For example, a transmission module 196 may be in communication with a processing module 110 of a cloud administration system 100.

In an embodiment, a stock usage system 193 may communicate with the cloud administration system 100. A stock usage system 193 may be located remotely from the cloud administration system 100. A stock usage system 193 may include one or more computing devices configured to monitor and/or track stock usage by one or more print devices. The stock usage system 193 may communicate with a cloud administration system over a network 198 through a firewall 194.

In an embodiment, a fault analysis system 195 may communicate with the cloud administration system 100. A fault analysis system 195 may be located remotely from the cloud administration system 100. A fault analysis system 195 may include one or more computing devices configured to monitor and analyze faults experienced by one or more print devices 104. The fault analysis system 195 may communication with the cloud administration system 100 over a network 181 through a firewall 183.

A supply ordering system 197 may communicate with the cloud administration system 100. A supply ordering system 197 may be located remotely from the cloud administration system 100. A supply ordering system 197 may include one or more computing devices configured to monitor a stock inventory for one or more print devices 104 and manage the reordering of stock for one or more print devices. The supply ordering system 197 may communication with the cloud administration system 100 over a network 177 through a firewall 175.

In an embodiment, a source computing device 120, an application computing device 130, a print device 140, a stock usage system 193, a fault analysis system 195 and/or a supply ordering system 197 may not communicate directly with one another. As illustrated by FIG. 1, the source computing device 120, the application computing device 130, the print device 140, the stock usage system 193, the fault analysis system 195 and the supply ordering system 197 may communicate indirectly via a cloud administration system 100.

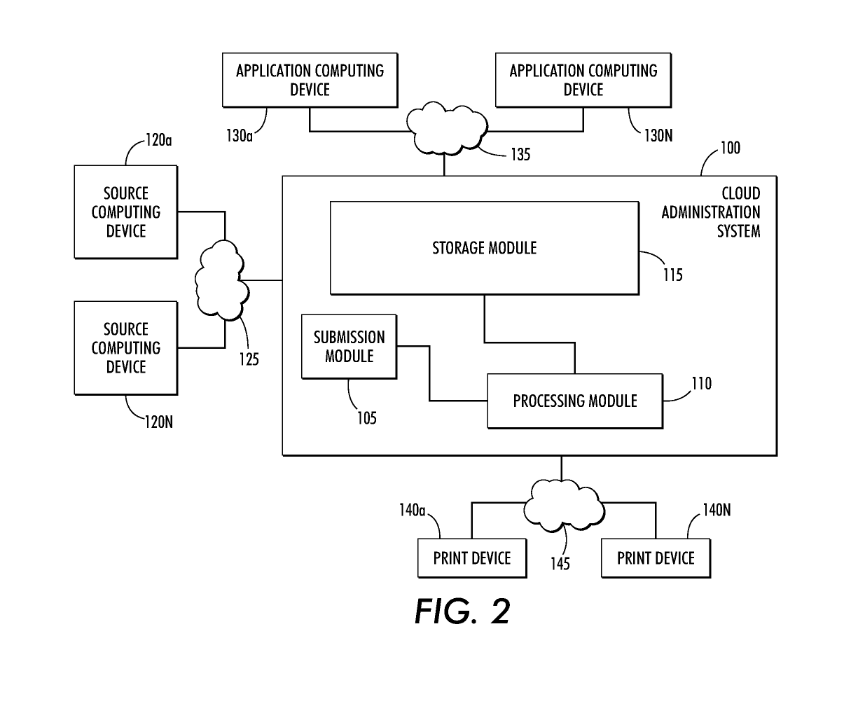

FIG. 2 depicts an example cloud administration system according to an embodiment. As illustrated by FIG. 2, a cloud administration system 100 may communicate with more than one source computing device 120a-N, application computing device 130a-N and/or print device 140a-N.

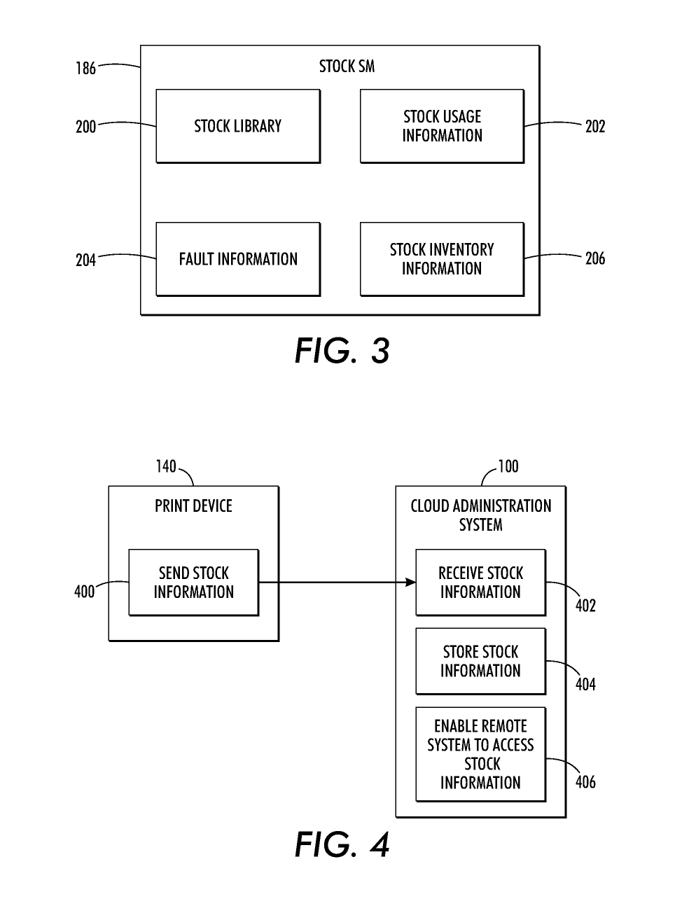

FIG. 3 illustrates an example of a stock storage module 186 according to an embodiment. As illustrated by FIG. 3, a stock storage module 186 may store a stock library 200. A stock library 200 may include information pertaining to one or more stocks used by one or more print devices 140a-N. For example, a stock library 200 may include a name, manufacturer, type, identifier, quality, base weight, grammage weight, color, thickness, finish, coating, standard cut sizes, best use practices for operation and/or other characteristics of stock. The stock library 200 may also include an indication of which print devices 140a-N have utilized and/or are utilizing the stock. In an embodiment, a stock library 200 may include an indication as to what region a stock corresponds. For example, a certain stock may only be used in a particular region, such as a country, an area and/or the like. FIG. 7 illustrates an example of stock library according to an embodiment.

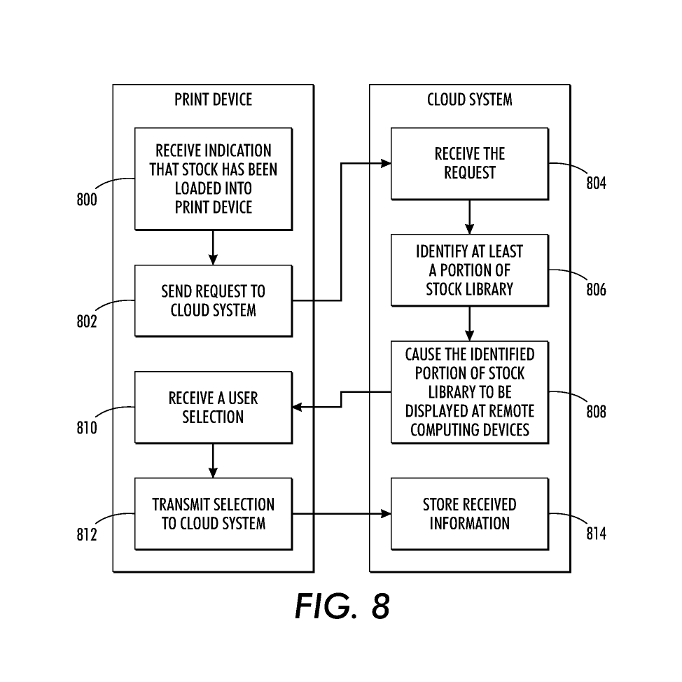

In an embodiment, at least a portion of a stock library may be accessed by a print device or other computing device. FIG. 8 illustrates an example method of accessing a stock library according to an embodiment. In an embodiment, when stock is loaded into a tray of a print device, a user of the print device may indicate 800 that stock has been added to the particular tray. In an embodiment, a user may indicate that stock has been added by making a selection via the print device. For example, a user may indicate that stock has been added to a tray by making a selection via a user interface of the print device. In an embodiment, a user may indicate that stock has been added by making a selection via a computing device. For example, a user may indicate that stock has been added via one or more web pages, graphical user interfaces and/or the like.

In an embodiment, a request may be sent 802 to a cloud system. In an embodiment, the request may be sent 802 by a print device and/or another computing device. A request may include an identifier associated with the print device to which stock was added.

The cloud system may receive 804 the request, and may use the print device identifier to identify 806 at least a portion of the stock library. The identified portion of the stock library may include one or more stocks that are available for use by the print device. For example, an identifier associated with a print device may be used to identify the make, model, type and/or the like associated with the print device. As another example, an identifier may be used to identify a region in which the print device is located. The cloud system may use this information to identify 806 which stocks from the stock library are available for use by the print device. For instance, the cloud system may access a database, list, table and/or the like of print device identifiers, makes, models, device types, regions and/or the like associated with the corresponding print devices. This database, list, table and/or the like may be stored in the cloud system or it may be stored remotely from the cloud system. For example, the cloud system may use a received print device identifier to determine that the print device is located in the United States. The cloud system may identify 806 stocks in the stock library that are available to print devices in the United States.

In an embodiment, a cloud system may cause 808 the identified portion of the stock library to be displayed at a remote computing device. For example, in an embodiment, the cloud system may cause 808 the identified portion of the stock library to be displayed on a display of the print device from which the request was received. In an embodiment, the cloud system may cause 808 the identified portion of the stock library to be displayed at another computing device located remotely from the cloud system.

In an embodiment, a user may select the stock that was added from the displayed portion of the stock library. The user may, for example, select the appropriate tray to which stock was added and then select from the displayed information the appropriate stock that was added to the tray. A print device and/or other computing device may receive 810 a user selection. In an embodiment, the selected tray and the selected stock may be transmitted 812 to the cloud system. The cloud system may store 814 this information. For example, the cloud system may store 814 this information in the stock storage module. As such, the cloud system may be able to track the stock that is used in one or more trays in one or more print devices. Table 1 illustrates example stock usage information according to an embodiment.

TABLE 1

| Print Device | Tray | Stock |
|---|---|---|
| Print Device 1 | Tray 1 | Stock A |
| Print Device 1 | Tray 2 | Stock B |
| Print Device 2 | Tray 1 | Stock C |
| Print Device 2 | Tray 2 | Stock A |
| Print Device 2 | Tray 3 | Stock D |
| Print Device 3 | Tray 1 | Stock B |

In an embodiment, a stock storage module may store stock usage information 202 pertaining to the usage of stock by one or more print devices. For example, a stock storage module may store stock usage information 202 pertaining to how much of a certain type of stock is used by a print device over a period of time. For instance, a stock storage module may store stock usage information 202 pertaining to how much of what stock a print device uses each day, each week, each month, each year and/or the like. Stock usage may include an average stock usage over a period of time. Additional and/or alternate time periods may be used within the scope of this disclosure. Table 2 illustrates an example of stock usage information 202 for Print Device 1 according to an embodiment.

TABLE 2

| Print | | | Amount Used (sheets) | | | | | | | |
|---|---|---|---|---|---|---|---|---|---|---|
| Device | Tray | Stock | Jan. 1, 2012 | Jan. 2, 2012 | Jan. 3, 2012 | Jan. 4, 2012 | Jan. 5, 2012 | Jan. 6, 2012 | Jan. 7, 2012 | Avg. |
| Print | Tray | Stock | 601 | 324 | 530 | 922 | 244 | 490 | 145 | 465.15 |
| Device | 1 | A | | | | | | | | |
| 1 | | | | | | | | | | |
| Print | Tray | Stock | 25 | 21 | 23 | 34 | 12 | 22 | 25 | 23.14 |
| Device | 2 | B | | | | | | | | |
| 1 | | | | | | | | | | |

In an embodiment, a stock storage module may store fault information 204 associated with stock usage. Fault information 204 may pertain to one or more faults relating to stock usage that are experienced by a print device over a period of time. Example faults may be paper jams, tray or feeder malfunctions, image quality defects and/or the like. Fault information 204 may include an identifier associated with the print device that experienced the fault, a time stamp of when the fault was encountered, a description of the fault encountered, identification of the stock being used when the fault was encountered and/or the like. Table 3 illustrates example fault information 204 according to an embodiment.

TABLE 3

| Print Device | Tray | Stock | Fault Description | Timestamp |
|---|---|---|---|---|
| Print Device 1 | Tray 1 | Stock A | Paper jam | 05/01/12 16:04:12 |
| Print Device 1 | Tray 2 | Stock B | Paper jam | 05/03/12 08:02:54 |
| Print Device 2 | Tray 1 | Stock C | Paper jam | 04/29/12 10:01:34 |
| Print Device 2 | Tray 2 | Stock A | Paper jam | 04/30/12 13:21:12 |
| Print Device 2 | Tray 3 | Stock D | Paper jam | 05/02/12 12:43:38 |
| Print Device 3 | Tray 1 | Stock B | Stock-caused | 05/04/12 09:14:58 |
| | | | image quality | |
| | | | defect | |

In an embodiment, stock usage information 202 may be received by a cloud administration from one or more print devices. A print device may transmit stock usage information 202 to the cloud administration system at regular intervals, such as, for example, once a day. In another embodiment, a print device may transmit stock usage information 202 to the cloud administration system periodically. In an embodiment, a print device may transmit stock usage information 202 to the cloud administration system in response to receiving a request for information from the cloud administration system. The cloud administration system may receive and store the stock usage information 202.

In an embodiment, fault information 204 may be received by a cloud administration from one or more print devices. A print device may transmit fault information 204 to the cloud administration system at regular intervals, such as, for example, once a day. In another embodiment, a print device may transmit fault information 204 to the cloud administration system periodically. In an embodiment, a print device may transmit fault information 204 to the cloud administration system in response to receiving a request for information from the cloud administration system. The cloud administration system may receive and store the fault information 204.

In an embodiment, a stock storage module may store stock inventory information 206 associated with one or more stocks and/or one or more print devices. The cloud administration system may enable a stock usage system to access at least a portion of stored stock usage information from a stock storage module. In an embodiment, a stock usage system may be able to generate one or more reports pertaining to stock information. A stock usage system may use stock usage information to track stock inventory and stock usage in order to provide a user of a print device with information pertaining to a current inventory of a stock at the print device. In an embodiment, stock inventory information 206 may include a current inventory level associated with a stock for one or more print devices. Stock inventory information 206 may pertain to individual print devices or to a group of print devices. For example, a stock storage module may store stock inventory information 206 pertaining to all print devices at a particular location, print devices in a particular department, print devices being used by a particular customer and/or the like. Table 4 illustrates example stock inventor information according to an embodiment.

TABLE 4

| | | Current Inventory Level |
|---|---|---|
| Print Device | Stock | (sheets) |
| Print Device 1 | Stock A | 900 |
| Print Device 1 | Stock B | 980 |
| Print Device 2 | Stock C | 753 |
| Print Device 2 | Stock A | 1,200 |
| Print Device 2 | Stock D | 554 |
| Print Device 3 | Stock B | 225 |

In an embodiment, stock information may refer to stock usage information 202, fault information 204 and/or stock inventory information 206. FIG. 4 illustrates a flow chart of an example method of utilizing stock information according to an embodiment. As illustrated by FIG. 4, stock information may be sent 400 by one or more print devices and received 402 by the cloud administration system. A transmission module 196 and/or a stock queue 192 of a print device may send stock information, and submission module 105 and/or processing module 110 of the cloud administration system 100 may receive 402 the stock information. In an embodiment, the cloud administration system 100 may store 404 the received stock information in the stock storage module 186.

In an embodiment, the cloud administration system may enable 406 a remote system to access the stored stock information. For example, the cloud administration system may enable 406 a stock usage system, a fault analysis system and/or an inventory management system to access the stored stock information. In an embodiment, a remote system may access stock information stored by a cloud administration system in order to perform one or more analytics on at least a portion of the stock information.

For example, a cloud administration system may enable 406 a stock usage system to access stock information to analyze one or more stock usage patterns or trends for one or more print devices. For example, a stock usage system may analyze historical stock usage information to determine how much and what types of stock a print device utilizes over a period of time. The stock usage system may analyze stock information to forecast future stock usage over a period of time by one or more print devices.

In an embodiment, a cloud administration system may enable 404 a fault analysis system to access stock information. A fault analysis system may monitor stock information to alert a user of faults experienced by one or more print devices. In an embodiment, a fault analysis system may monitor fault information associated with one or more print devices. If the number of faults experienced by one or more print devices exceeds a threshold value, the fault analysis system may notify a user, operator and/or the like. In an embodiment, a fault analysis system may analyze stock information to identify one or more patterns or trends between stock usage and experienced faults for one or more print devices. For example, a fault analysis system may analyze stock information for a print device and determine that 80% of the faults experienced by Print Device 1 occur when Print Device 1 is using Stock A. The fault analysis system may notify a user or operator of any detected patterns or trends, and may make one or more recommendations based on identified patterns or trends. For example, a fault analysis system may recommend that a user or operator of Print Device 1 switch to Stock B to reduce the number of faults Print Device 1 experiences.

In an embodiment, a fault analysis system may utilize auxiliary information in analyzing stock information. For example, a fault analysis system may analyze environmental information associated with a print device over a period of time in conjunction with fault information in order to determine one or more patterns or trends. Environmental information may include a temperature, humidity and/or other environmental measurements associated with a print device over a period of time. For example, a fault analysis system may analyze environmental information and fault information for a print device to determine that a majority of the faults experienced by the print device occur when the print device is using Stock A and the area within which the print device is located experiences humidity in excess of 75%. The fault analysis system may use this information to recommend another stock that is less susceptible to humidity.

In an embodiment, at least a portion of auxiliary information may be obtained from the cloud administration system. In another embodiment, at least a portion of auxiliary information may be obtained from a system other than the cloud administration system, such as, for example, a print device, a remote computing device, a remote system and/or the like.

In an embodiment, a cloud administration system may enable 406 a inventory management system to access at least a portion of stock information. An inventory management system may analyze stock information to determine whether additional inventory of stock should be ordered for one or more print devices. In an embodiment, an inventory management system may determine that additional stock should be ordered if the current inventory of stock for one or more print devices, individually or in the aggregate, does not exceed a threshold value. A threshold value may be a certain amount of stock, an average amount of stock usage over a period of time and/or the like. For example, an inventory management system may determine that additional stock should be ordered for a print device if the current inventory level of stock is less than an average stock usage by the print device over a two-week period. For instance, referring back to Table 2 and Table 4, the cloud administration system may determine that additional inventory of Stock A should be ordered for Print Device 1 because the current inventory level of Stock A for Print Device 1 (i.e., 900) is less than the average stock usage by Print Device 1 for a two-week period (i.e., 465.15 sheet/week*2 weeks).

In an embodiment, if the inventory management system determines that additional stock should be ordered, the inventory management system may automatically order additional stock. In an alternate embodiment, the inventory management system may notify a user that additional stock should be ordered. For example, the inventory management system may send a notification, such as an email, an alert, or other message to a user or operator of a print device notifying the user or operator that additional stock should be ordered.

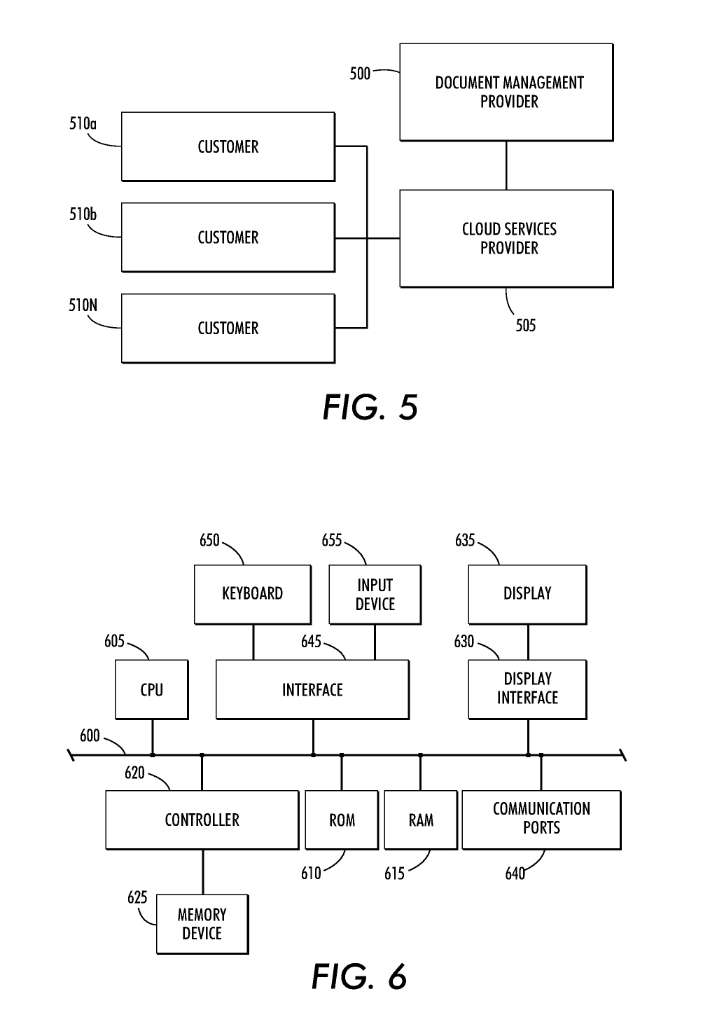

FIG. 5 illustrates an example implementation of a cloud administration system according to an embodiment. A document management provider 500 may contract with a cloud services provider 505 to provide cloud services to the document management provider's customers 510a-N. A document management provider 500 may be an entity that supplies, manages and/or maintains print devices, processes print jobs and/or performs other document management services. A cloud services provider 505 may operate and/or maintain a cloud administration system to provide cloud services. Cloud services may describe applications that may be accessed on demand from a cloud services provider that hosts the applications. Cloud services may include applications for document management, document processing, account management, print device configuration, document retention and backup, inventory management, stock analysis, fault analysis and/or the like. In an embodiment, a computing device operated by a customer 510a-N may communicate directly with a cloud administration system.

FIG. 6 depicts a block diagram of example internal hardware that may be used to contain or implement program instructions according to embodiments. A bus 600 serves as the main information highway interconnecting the other illustrated components of the hardware. CPU 605 is the central processing unit of the system, performing calculations and logic operations required to execute a program. CPU 605, alone or in conjunction with one or more of the other elements disclosed in FIG. 6, is an example processing device, computing device or processor as such terms are used within this disclosure. Read only memory (ROM) 610 and random access memory (RAM) 615 constitute example memory devices or processor-readable storage media.

A controller 620 interfaces with one or more optional memory devices 625 to the system bus 600. These memory devices 625 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 610 and/or the RAM 615. Optionally, the program instructions may be stored on a tangible computer readable medium such as a compact disk, a digital disk, flash memory, a memory card, a USB drive, an optical disc storage medium, such as a Blu-ray™ disc, and/or other recording medium.

An optional display interface 630 may permit information from the bus 600 to be displayed on the display 635 in audio, visual, graphic or alphanumeric format. Communication with external devices, such as a print device, may occur using various communication ports 640. An example communication port 640 may be attached to a communications network, such as the Internet or an intranet.

The hardware may also include an interface 645 which allows for receipt of data from input devices such as a keyboard 650 or other input device 655 such as a mouse, a joystick, a touch screen, a remote control, a pointing device, a video input device and/or an audio input device.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A cloud administration system for managing stock information in a network printing context, the system comprising:
a processing module in communication with a plurality of print devices, wherein the processing module is located remotely from the plurality of print devices; and
one or more storage modules in communication with the processing module,
wherein the processing module is configured to:
receive stock information from at least one of the plurality of print devices,
store the stock information in at least one of the storage modules, and
enable a remote system to access at least a portion of the stock information from the storage module, wherein the remote system is located remotely from the processing module,
wherein the cloud administration system operates as a shared resource for each of the plurality of print devices and the remote system.

2. The cloud administration system of claim 1, wherein the processing module is configured to receive stock information from a stock queue associated with at least one of the plurality of print devices.

3. The cloud administration system of claim 1, wherein the processing module is configured to:
receive stock usage information from the at least one of the plurality of print devices, wherein the stock usage information comprises information pertaining to stock used by the at least one of the plurality of print devices over a period of time;
store the stock usage information in a stock storage module; and
enable a stock usage system to access at least a portion of the stock usage information from the stock storage module.

4. The cloud administration system of claim 1, wherein the processing module is configured to:
receive fault information from the at least one of the plurality of print devices, wherein the fault information comprises information pertaining to one or more faults experienced by the at least one of the plurality of print devices over a period of time;
store the fault information in a stock storage module; and
enable a fault analysis system to access at least a portion of the fault information from the stock storage module.

5. The cloud administration system of claim 1, wherein the processing module is configured to:
receive stock inventory information from the at least one of the plurality of print devices, wherein the stock inventory information comprises information pertaining to a current inventory level associated with one or more stocks used by the at least one of the plurality of print devices;
store the stock inventory information in a stock storage module; and
enable an inventory management system to access at least a portion of the stock inventory information from the stock storage module.

6. A system for managing stock information in a network printing context, the system comprising:
a computing device; and
a computer-readable storage medium in communication with the computing device, wherein the computer-readable storage medium comprises one or more programming instructions that, when executed, cause the computing device to:
access, from a storage module of a cloud administration system, stock information associated with one or more print devices in communication with the cloud administration system,
analyze the accessed stock information to identify one or more patterns associated with the accessed stock information,
alert a user of the one or more print devices of the identified patterns, and
present the user with one or more recommendations based on the identified patterns.

7. The system of claim 6, wherein:
the one or more programming instructions that, when executed, cause the computing device to access stock information comprise one or more programming instructions that, when executed, cause the computing device to access stock usage information comprising information pertaining to stock used by the at least one of the plurality of print devices over a period of time; and
the one or more programming instructions that, when executed, cause the computing device to analyze the accessed stock information to identify one or more patterns comprise one or more programming instructions that, when executed, cause the computing device to identify historical stock usage associated with the at least one of the plurality of print devices over the period of time, and forecast a future stock usage for a future time period based on the historical stock usage.

8. The system of claim 6, wherein:
the one or more programming instructions that, when executed, cause the computing device to access stock information comprise one or more programming instructions that, when executed, cause the computing device to access fault information comprising information pertaining to one or more faults experienced by the at least one of the plurality of print devices over a period of time; and
the one or more programming instructions that, when executed, cause the computing device to analyze the accessed stock information to identify one or more patterns comprise one or more programming instructions that, when executed, cause the computing device to identify one or more patterns of stock usage and faults experienced by the at least one of the plurality of print devices.

9. The system of claim 6, wherein:
the one or more programming instructions that, when executed, cause the computing device to access stock information comprise one or more programming instructions that, when executed, cause the computing device to access stock inventory information comprising information pertaining to a current inventory level of one or more stocks used by the at least one of the plurality of print devices; and
the one or more programming instructions that, when executed, cause the computing device to analyze the accessed stock information to identify one or more patterns comprise one or more programming instructions that, when executed, cause the computing device to determine whether additional inventory of the one or more stocks should be ordered.

10. A method of managing stock information in a network printing context, the method comprising:
receiving, by a cloud administration system from a print device located remotely from the cloud administration system, stock information associated with the print device;
storing, by the cloud administration system, the stock information in a storage module;
enabling, by the cloud administration system, a remote system to access at least a portion of the stock information from the storage module; and
wherein the cloud administration system operates as a shared resource for each of the plurality of print devices and the remote system.

11. The method of claim 10, wherein receiving stock information comprises receiving stock information from a stock queue associated with the print device.

12. The method of claim 10, wherein:
receiving stock information comprises receiving stock usage information comprising information pertaining to stock used by the at least one of the plurality of print devices over a period of time;
storing the stock information in a storage module comprises storing the stock information in a stock storage module; and
enabling a remote system to access at least a portion of the stock information comprises enabling a stock usage system to access at least a portion of the stock usage information from the stock storage module.

13. The method of claim 10, wherein:
receiving stock information comprises receiving fault information pertaining to one or more faults experienced by the at least one of the plurality of print devices over a period of time,
storing the stock information in a storage module comprises storing the fault information in a stock storage module; and
enabling a remote system to access at least a portion of the stock information comprises enabling a fault analysis system to access at least a portion of the fault information from the stock storage module.

14. The method of claim 10, wherein:
receiving stock information comprises receiving stock inventory information from the at least one of the plurality of print devices, wherein the stock inventory information comprises information pertaining to a current inventory level associated with one or more stocks used by the at least one of the plurality of print devices.
storing the stock information in a storage module comprises storing the inventory information in a stock storage module; and
enabling a remote system to access at least a portion of the stock information comprises enabling an inventory management system to access at least a portion of the stock inventory information from the stock storage module.

15. A method of managing stock information in a network printing context, the method comprising:
receiving, by a cloud administration system, a request to access at least a portion of the information in a stock library, wherein the stock library comprises information pertaining to one or more stocks, wherein the request comprises an identifier associated with a print device;
identifying, by the cloud administration system, one or more possible stocks that are available for use by the print device from the stock library based on the identifier;
causing information associated with the identified possible stocks to be displayed at the print device;
receiving a selection of one of the identified possible stocks;
receiving an indication of a tray of the print device associated with the selected stock; and
storing, by the cloud administration system, the selection and the indication in the stock storage module.

16. The method of claim 15, wherein identifying one or more possible stocks that are available for use by the print device from the stock library based on the identifier comprises:
determining a print device type associated with the print device; and
identifying one or more possible stocks from the stock library that correspond to the print device type.

17. The method of claim 15, wherein identifying one or more possible stocks that are available for use by the print device from the stock library based on the identifier comprises:
determining a geographical region associated with the print device; and
identifying one or more possible stocks from the stock library that correspond to the geographic region.

18. The method of claim 15, wherein causing information associated with the identified possible stocks to be displayed at the print device comprises causing one or more of the following to be displayed for each identified possible stock at the print device:
a size;
a weight;
a coating type;
a color;
a thickness;
a finish; and
one or more geographical regions in which the identified possible stock is available.
